(19) United States
(12) Patent Application Publication
(10) Pub. No.: US 2014/0318408 A1
(43) Pub. Date: Oct. 30, 2014

(54) Drive Apparatus for a Magnetic Levitation Transport System

(71) Applicant: Max Bögl Bauunternehmung GmbH & Co. KG, Sengenthal (DE)

(72) Inventors: Stefan Bögl, Sengenthal (DE); Xiufei Liu, Poing (DE)

(73) Assignee: Max Bogl Bauuntemehmung GmbH & Co. KG, Sengenthal (DE)

(21) Appl. No.: 14/363,469

(22) PCT Filed: Dec. 7, 2012
(86) PCT No.: PCT/EP2012/074748

§ 371 Date: Jun. 6, 2014

(30) Foreign Application Priority Data
Dec. 8, 2011 (DE) 10 2011 056 183.8

(51) Int. Cl. B60L 13/03; B61C 17/00; H02K 41/02; B61C 3/00

(52) U.S. Cl. CPC B60L 13/03; B61C 3/00; B61C 17/00; H02K 41/02
USPC 104/291

(57) ABSTRACT

The present invention relates to a drive apparatus for a magnetic levitation transport system comprising a short-stator linear motor, wherein a primary part of the linear motor is provided with a winding (8) and is intended for arrangement on a vehicle (12) of the magnetic levitation transport system. A secondary part of the linear motor has a reaction rail (2) and is intended for arrangement on a travel path (1), with a supporting device for the magnetic levitation of the vehicle (12) on the travel path (1). The supporting device has at least one electromagnetic coil (4) attended for arrangement on the vehicle (12) and having a U-shaped yoke (3), which interacts with a U-shaped reaction rail (2) intended for arrangement on the travel path (1). The short-stator linear motor is surrounded by the U-shaped yoke (3) and the U-shaped reaction rail (2) on both sides transversely to the longitudinal extent of said short-stator linear motor.

The present invention relates to a drive apparatus for a magnetic levitation transport system with a short-stator linear motor, wherein a primary part of the linear motor is provided with a winding and is arranged on a vehicle of the magnetic levitation transport system, and a secondary part of the linear motor features a reaction rail and is arranged on a vehicle, along with a supporting device for the levitation of the vehicle on the travel path.

With the short-stator linear motor in accordance with the invention, the primary part of the linear motor, which is supplied with power, is located on the vehicle. The less technically complex secondary part of the linear motor is arranged on the travel path. Therefore, in contrast to a long-stator linear motor, for which the primary part is arranged on the travel path, the travel path is considerably cheaper to produce.

Short-stator linear motors for magnetic levitation transport systems are known from, for example, DE 28 01 602 A1 or DE 100 00 513 C1. It is common for both devices that separate electromagnetic devices are provided for carrying and guiding the vehicle. The devices for carrying and guiding the vehicle are arranged in alternation and in succession on the vehicle, such that the magnetic levitation transport system can be operated in a way that is comfortable and balanced in terms of forces. Alternatively, it is also proposed that the devices for carrying and guiding the vehicle are arranged in alternation on both sides of the vehicle.

With both embodiments, it is disadvantageous that the structural length of the drive apparatus for carrying and guiding is very large, such that, in particular with short vehicles, only a small part of the vehicle length is available for driving or carrying the vehicle.

Therefore, the task of the present invention is to create a drive apparatus of a magnetic levitation transport system that is cost-efficient and requires only a small installation space that, both for the support function and the propulsion function, is operated in a manner disruption-free and efficient in terms of energy, and is easy to control.

The present task is solved with a drive apparatus for a magnetic levitation transport system with the characteristics of the independent claims.

The drive apparatus in accordance with the invention features a short-stator linear motor and a supporting device. The short-stator linear motor is used to drive a vehicle of a magnetic levitation transport system, while the supporting device is provided for the levitation of the vehicle on the travel path of the magnetic levitation transport system. The short-stator linear motor features a primary part of the linear motor with a winding, which is arranged on a vehicle of the magnetic levitation transport system. A secondary part of the linear motor features a reaction rail, and is arranged on the travel path of the magnetic levitation transport system. The primary part of the linear motor is supplied with power through the vehicle. Thereby, the vehicle can either carry along a generator, or be provided with power by an external generator through contact rails or cable connections.

The linear motor is used to drive or propel the vehicle. In contrast, the supporting device brings about contact-free levitation, thus the support function of the vehicle on the travel path. It features an electromagnetic coil arranged on the vehicle, with a U-shaped yoke. The U-shaped yoke interacts with a U-shaped reaction rail arranged on the travel path. If power flows through the electromagnetic coil, this generates a force that attempts to attract the U-shaped yoke to the U-shaped reaction rail. Thereby, with a corresponding arrangement of the supporting device between a bottom side of the vehicle and a top side of the vehicle, the vehicle is lifted, and levitates on the travel path without any contact and with a corresponding control.

Thereby, the magnetic flux of the supporting device is essentially aligned perpendicular to the magnetic flux of the linear motor, such that they affect each other as little as possible.

In accordance with the invention, the short-stator linear motor is surrounded by the U-shaped yoke and the U-shaped reaction rail on both sides transversely to the longitudinal extent of said short-stator linear motor. Thus, the short-stator linear motor, which stretches along the travel path, is located within the supporting device formed with a U-shape or a trough shape. Thereby, the primary part of the linear motor is arranged between the two arms of the U-shaped yoke, and the secondary part of the linear motor is located between the two flanges of the U-shaped reaction rail of the supporting device. This arrangement gives rise to a compact, material-saving and low-cost fastening of the linear motor to the supporting device. Thereby, the units from the primary part of the linear motor and the yoke of the support device are fastened to the vehicle, while the units from the secondary part of the linear motor and the reaction rail of the supporting devices are arranged on the travel path. In addition, this allows for a simple control and excellent driving dynamics, since, through this arrangement, little torque arises between the supporting device and the short-stator linear motor.

Preferably, the winding of the linear motor is arranged in an iron core. In a known manner, the iron core consists of a multitude of sheets arranged against each other, which feature grooves in which the winding for the linear motor is arranged.

In order to reduce the thermal load of the linear motor and the supporting device due to losses of efficiency, and to avoid the overheating of the linear motor, it is advantageously provided that a cooling system for the linear motor is arranged between the U-shaped yoke of the supporting device and the primary part of the linear motor and/or below the primary part of the linear motor.

Preferably, the cooling system is arranged on the iron core of the linear motor. It is located, for example, between the iron core and the bottom of the U-shaped yoke.

In addition or as an alternative to the cooling system on the iron core of the linear motor, it is also advantageous if the cooling system is arranged on the U-shaped yoke of the supporting device and/or below the linear motor. Thereby, it may be provided both on the flanges of the U-shaped yoke, and on its bottom.

In a particularly advantageous embodiment of the cooling system, it is provided as a water cooling system. The water cooling system can be connected to a cooling system, which is arranged in the vehicle, and, for example, is always supplied with cooling fluid through a heat exchanger. Of course, it is possible for the cooling system to use a fluid other than water. It must be suitable, in particular, for the transfer of heat, and for the rapid absorption and release of heat. Alternatively, an active or passive air cooling system that, through ventilators or air ducts, allows cooling air to stream to the heat-producing components of the linear motor or the supporting device is, of course, also possible.

Preferably, the reaction rail of the secondary part of the linear motor is a number of short bars or one metal plate. In particular, aluminum has proved itself especially useful as the material for the reaction bar.

In a particularly advantageous embodiment of the invention, the coil of the supporting device is wound around a y-axis that is arranged horizontally to the operation of the system, transversely to the longitudinal direction of the linear motor. Alternatively, this would also be possible around a vertical axis and/or a z-axis, whereas, in such a case, the coil would be wound around the flange of the yoke.

However, in the preferred embodiment of the invention, the coil is wrapped around the bottom of the U-shaped yoke.

It is especially advantageous if, for each supporting device, at least two coils are provided along the x-axis and/or at least two coils are provided along the y-axis. Through these two or four coils, as the case may be, a higher load capacity is produced, and a more uniform rising of the vehicle is also brought about. Moreover, manufacturing is made easier, and the installation space is able to be designed to be very small. Preferably, both coils are wound around a horizontal axis, such that, with a symmetric arrangement of the coils, a uniform distribution force of the drive apparatus is generated.

In order to achieve a stable fastening of the primary part of the linear motor, it is advantageously provided that the primary part is fastened to the U-shaped yoke of the supporting device. Thereby, the fastening may take place both at the two flanges of the yoke and also on its bottom, preferably between the two coils, with the use of bars.

Preferably, several modules of the drive apparatus, consisting of the primary part of the linear motor and the electromagnetic coils with a U-shaped yoke of the supporting device, are arranged on the vehicle. Thereby, both the manufacturing of the units and installation and interchangeability are made easier.

If the modules are arranged in the longitudinal direction of the vehicle, the mobility of the vehicle is improved by joint locations that are arranged in the vehicle. Thereby, smaller curve radii of the vehicle can be passed through.

If the modules are arranged on both sides of the travel path on the vehicle, this ensures a stable supporting and drive function of the vehicle.

In particular, if five modules per side are provided, if there is a customary length of the vehicle and radii of the travel path, a sufficient mobility of the vehicle is possible. Thereby, the vehicle is supported and driven in a balanced manner, such that a comfortable operation of the vehicle is ensured.

Preferably, the side yoke of the support unit in one module is provided with a groove. In an advantageous manner, this causes the assembly of the coils and the module on the vehicle to be made easier. The groove interrupts the connection bar of the yoke, and is particularly found in the flanges of the yoke. Advantageously, this serves the purpose of reducing the magnetic losses of the module.

If the side yoke of the support unit features different thicknesses, this brings about an optimization of the magnetic flux and thus an energy savings and/or an increase in load capacity.

In a particularly advantageous embodiment of the invention, the drive apparatus is formed in such a manner that the short-stator linear motor is arranged in a housing. The linear motor is located between the two flanges of the U-shaped yoke of the supporting device. The supporting device is operated with direct current, while the linear motor is operated with a controlled alternating current. In order to avoid unwanted interference of the two electrical systems as much as possible, the linear motor is located in a housing. The housing, which is preferably made of metal (for example, stainless steel, copper or aluminum), sufficiently shields the two systems from each other, such that a selected and predetermined operation of the two systems, in particular of the linear motor, is ensured. The metal is preferably conductive, and is not magnetizable or only barely magnetizable.

Advantageously, the housing is filled with a material, in particular a casting compound or sprayed material, such as resin or silicone. This gives rise to a compact structural unit, which, in addition to the electric shielding effect, protects the linear motor from environmental influences. In addition, vibrations and noise are reduced through the iron core and the coil.

If a fastening device, in particular a wedge system, is arranged between the housing and the yoke, a solid, vibration-free fastening of the linear motor and/or the winding, and of the core between the two flanges of the yoke, is possible. Thereby, the wedge system clamps the housing of the linear motor between the two flanges, and ensures a stable setting upon the vibration of the drive.

If the fastening device is formed in a tension-equalizing fashion, or is made from a tension-equalizing (for instance, elastic) material, a firm connection between the linear drive and the supporting device is always created.

In accordance with the invention, the drive apparatus is installed in a magnetic levitation transport system with a travel path and a vehicle.

The invention is not limited to the described advantages. Additional advantages of the invention are described in the following embodiments. The following is shown:

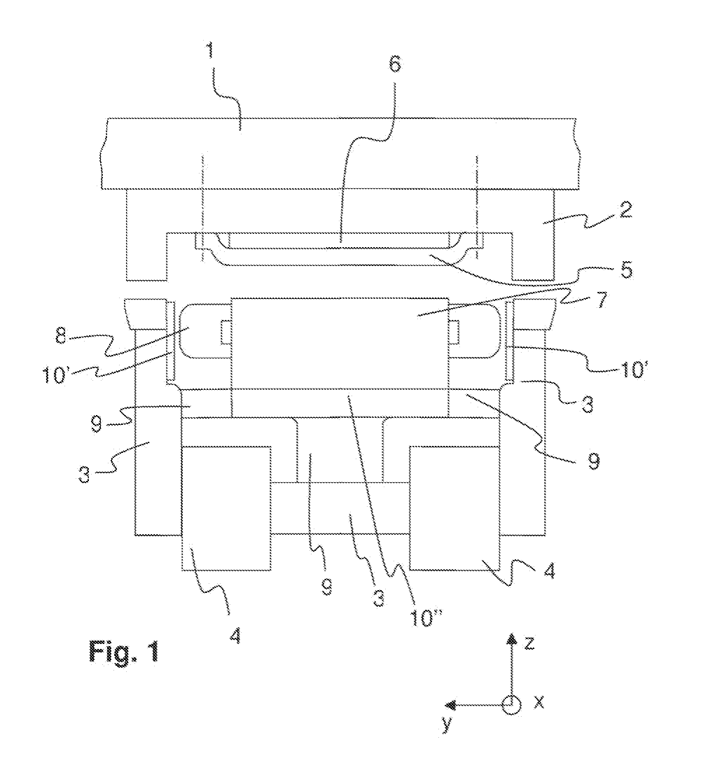

FIG. 1 a cross-section of a drive apparatus in accordance with the invention

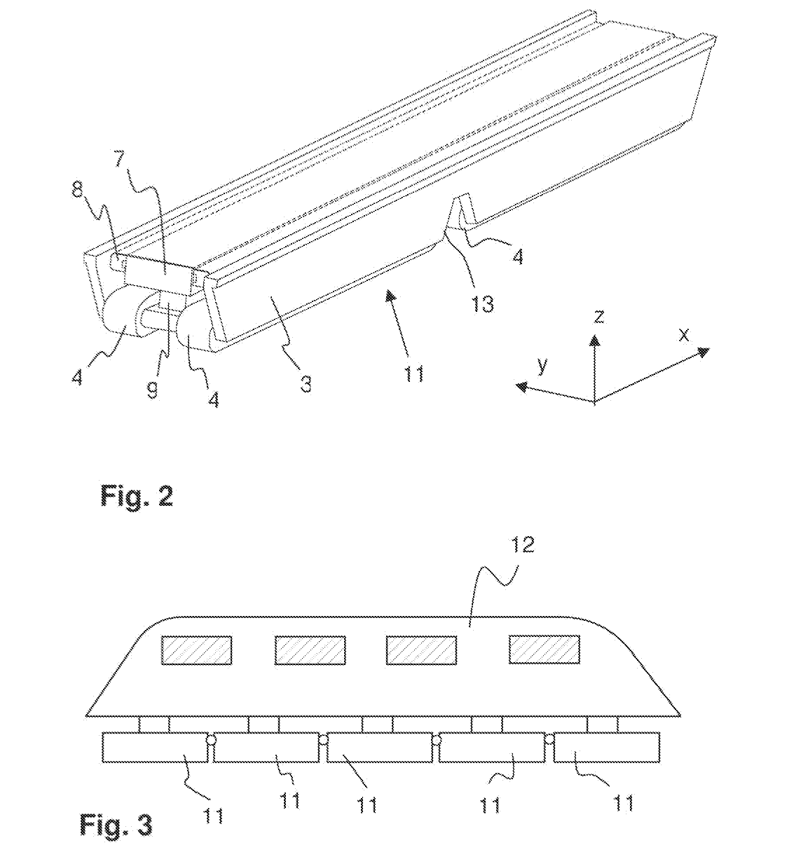

FIG. 2 a perspective view of a module,

FIG. 3 a side view of a vehicle with several modules and

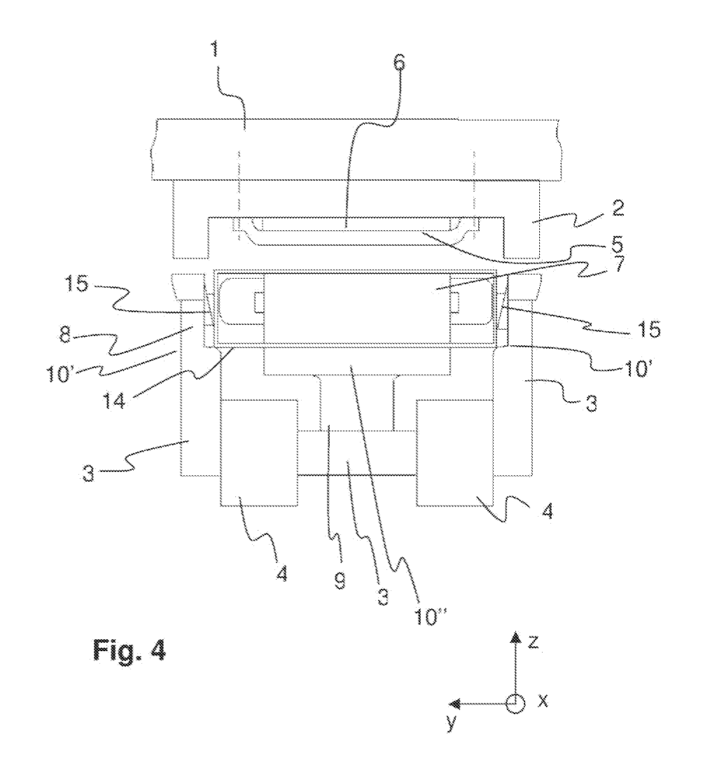

FIG. 4 a cross-section of an additional drive apparatus in accordance with the invention.

FIG. 1 shows a cross-section of a drive apparatus of a magnetic levitation transport system in accordance with the invention with a short-stator linear motor along with a supporting device for levitating a vehicle of the magnetic levitation transport system. A reaction rail 2 is fastened to a travel path 1. The reaction rail 2 is designed in a U-shape, whereas the free flanges of the U-shaped reaction rail 2 lift in a z-direction away from the travel path 1. The reaction rail 2 stretches longitudinally across an x-axis along the travel path 1. The reaction rail 2 is a component of a supporting device for a vehicle 12 of a magnetic levitation transport system shown in FIG. 3.

An additional component of the supporting device consists of a U-shaped yoke 3 and the coils 4 surrounding this yoke 3. The free flanges of the U-shaped yoke 3 are aligned in a positive z-direction on the free flanges of the reaction rail 2, and interact with them. The coils 4 are wrapped around a y-axis or the connection of the free flanges of the yoke 3, as the case may be. Alternatively, they could also be wound around the free flanges of the yoke 3, thus around a z-axis.

If power is applied to the coils 4, they produce a force on the reaction rail 2, which attempts to attract the yoke 3 at the reaction rail 2. The yoke 3 is connected to the vehicle 12 of the magnetic levitation transport system, by which this is lifted when there is a corresponding strength of the attraction force. Thereby, the attraction force is governed in such a manner that the vehicle 12 is lifted from the travel path 1 and, on the other hand, the yoke 3 does not come into contact with the reaction bar 2. This results in a levitation of the vehicle 12 of the magnetic levitation transport system on the travel path 1.

A linear motor is arranged within the two “U′s” of the reaction rail 2 and the yoke 3 of the supporting device. The linear motor features a metal plate 5, made of aluminum (for example), and a reaction rail 6, made of iron (for example). The metal plate 5 and the reaction rail 6 are arranged within the U-shaped reaction rail 2. The metal plate 5 is preferably made of aluminum. Furthermore, the linear motor consists of an iron core 7 and the windings 8. The iron core 7 is arranged within the U-shaped yoke 3 by means of the attachments 9. As presented in this embodiment, the attachment 9 may be present both on the free flanges of the yoke 3 and on the base of the “U′s” of the yoke 3. In particular, this has the advantage that an especially good absorption of forces is enabled.

A multitude of windings 8 are arranged in the iron core 7. If the windings 8 are supplied with power, propulsion in an x-direction arises, whereas the primary part of the linear motor, which is arranged on the U-shaped yoke 3, is shifted in respect of the secondary part of the linear motor in the form of the metal plate 5. This moves the vehicle 12 of the magnetic levitation transport system in an x-direction along the travel path 1.

To avoid the overheating of the linear motor, cooling systems 10 are arranged between the linear motor and the supporting device. In the embodiment that is shown, cooling devices 10′ are located between the iron core 7 and free flanges of the yoke 3. In addition, a cooling system 10″ is provided between the iron core 7 and the base of the yoke 3 and/or the attachments 9. Such cooling systems 10′ and 10″ are preferably water cooling systems, in order to be able to dissipate the heat that arises as quickly as possible. These water or fluid cooling systems can be incorporated into a fluid circuit, in order to be able to lead heat from the drive apparatus to, for example, a heat exchanger.

FIG. 2 shows a perspective view of a module 11 of a drive apparatus. The module 11 is fastened to a vehicle 12 of the magnetic levitation transport system. Each vehicle 12 features a multitude of such modules 11. In a particularly advantageous embodiment of the invention, modules 11 are arranged on both sides of the vehicle 12, whereas each side features five of such modules 11. Thereby, an ideal power distribution on the vehicle of a usual length is possible.

In each module 11 of the presented embodiment, four coils 4 are provided. The coils 4 are wrapped around the connection bar of the yoke 3 in an axis in a y-direction. Between the two coils 4 of a module 11, the attachment 9 for the iron core 7 is arranged on the connection bar of the yoke 3. The yoke 3 surrounds the iron core 7, and thereby, on the one hand, protects the primary part of the linear motor and, on the other hand, forms a very compact structural unit for the supporting device and the linear motor.

A multitude of windings 8 is arranged in the iron core 7. In the view of FIG. 2 that is presented, such windings 8 are drawn only with dotted lines. The primary part of the linear motor in the form of the iron core 7 and the windings 8 essentially extends across the entire length of the module 11.

Each of the coils 4 of the supporting device extends across roughly half of the module 11. Accordingly, four coils 4 are provided for each module 11. This facilitates the manufacturing of the coils 4 and the supporting device. Between the coils 4 following each other in succession in the longitudinal direction, the free flanges of the yoke 3 are equipped with an opening or a groove 13. The groove 13 brings about, on the one hand, an interruption of the connection bar of the yoke 3 and, on the other hand, a notch in the free flanges of the yoke 3. Thereby, the coils 4 can be better wound, and the magnetic losses can be reduced.

In contrast, the top sides of the free flange of the yoke 3 pass through, in order to achieve good load bearing properties of the supporting device. In addition, the stability of the module 11 is thereby improved.

FIG. 3 outlines a side view of the vehicle 12. It is evident from this that five modules 11 are arranged on the bottom side of the vehicle 12. Five other such modules 11 are located on the opposite side of the vehicle 12. Each of the modules 11 is fastened to the vehicle 12. The fastening may be a bogie, or permit only a lateral shifting relative to the longitudinal axis of the vehicle 12. As shown here, the modules 11 can be connected to each other in an articulated fashion, or fastened to the vehicle independent of each other. With a rigid version of the vehicle 12, driving along a curve is possible, even with narrow radii of the space curve of the travel path 1.

FIG. 4 shows an additional embodiment of the invention in accordance with the invention. The individual elements essentially correspond to the version under FIG. 1. However, in contrast to this, the iron core 7 and the winding 8 of the linear motor are arranged in a housing 14. The housing 14 completely encloses the iron core 7 and the winding 8.

The hollow space between the iron core 7, the winding 8 and the housing can be filled with a material, for example, by injecting or casting it. This material, e.g. resin or silicone, brings about additional stability for the device and, in addition, a certain insulation against environmental influences, such as humidity or dirt.

In this embodiment, a fastening device 15 consists of a wedge system that, with the assistance of two wedges, clamps the housing 14 between the flanges of the yoke 3. This brings about a stable fastening of the iron core 7 and the winding 8.

Preferably, the fastening device 15 is designed in such a manner that there can be compensation of tensions; for example, those based on the thermal expansion of the linear motor in respect of the supporting device. For this purpose, for example, the material of the fastening device 15 can be elastic, or the wedge system gives in upon appropriate pressure.

The invention is not limited to the presented embodiments. Variations within the framework of the patent claims are possible at any time. In particular, the arrangement of the drive apparatus on the vehicle may be presented other than as presented here. For its guidance, the vehicle may encompass the travel path on the inside or outside. It can be provided with only one row, or several rows, of modules.

### LIST OF REFERENCE SIGNS

1 Travel path
2 Reaction rail of the supporting device
3 Yoke
4 Coils of the support magnets
5 Metal plate
6 Reaction rail of the linear motor
7 Iron core
8 Winding of the linear motor
9 Attachments of the iron core 8
10′, 10″ Cooling systems
11 Module

12 Vehicle
13 Opening/groove
14 Housing
15 Fastening device

1. Drive apparatus for a magnetic levitation transport system comprising a short-stator linear motor, wherein a primary part of the linear motor is provided with a winding (8) and is intended for arrangement on a vehicle (12) of the magnetic levitation transport system and a secondary part of the linear motor has a reaction rail (2) and is intended for arrangement on a travel path (1), along with a supporting device for the magnetic levitation of the vehicle (12) on the travel path (1), characterized in that the supporting device has at least one electromagnetic coil (4) intended for arrangement on the vehicle (12) and having a U-shaped yoke (3), which interacts with a U-shaped reaction rail (2) intended for arrangement on the travel path (1) and that the short-stator linear motor is surrounded by the U-shaped yoke (3) and the U-shaped reaction rail (2) on both sides transversely to the longitudinal extent of said short-stator linear motor.

2-21. (canceled)
